(19) United States
(12) Patent Application Publication
(10) Pub. No.: US 2024/0172224 A1
(43) Pub. Date: May 23, 2024

(54) TRANSMISSION AND/OR RETRANSMISSION SCHEMES FOR DATA IN SYSTEMS WITH HIGH CARRIER FREQUENCIES

(71) Applicant: Intel Corporation, Santa Clara, CA (US)

(72) Inventors: Gang Xiong, Portland, OR (US); Alexei Davydov, Nizhny Novgorod (RU); Yingyang Li, Beijing (CN); Daewon Lee, Portland, OR (US); Seunghee Han, San Jose, CA (US)

(21) Appl. No.: 18/549,140

(22) PCT Filed: Mar. 1, 2022
(86) PCT No.: PCT/US2022/018267

§ 371 Date: Sep. 5, 2023

Related U.S. Application Data
(60) Provisional application No. 63/160,571, filed on Mar. 12, 2021.
(60) Provisional application No. 63/160,577, filed on Mar. 12, 2021.

(51) Int. Cl. H04W 72/1268; H04L 1/08; H04L 5/00; H04W 72/21; H04W 72/232

(52) U.S. Cl. CPC H04W 72/1268; H04L 1/08; H04L 5/0051; H04W 72/21; H04W 72/232

(57) ABSTRACT

Various embodiments herein provide techniques related to transmission and retransmission of data in systems that are operating with carrier frequencies above approximately 52.6 gigahertz (GHz). Some embodiments herein may refer to an enhanced transmission scheme for UCI. Some embodiments may additionally or alternatively relate to mixed initial transmission and retransmission of data channels for higher carrier frequencies. Other embodiments may be described and/or claimed.

### CROSS REFERENCE TO RELATED APPLICATION

The present application claims priority to U.S. Provisional Patent Application No. 63/160,571, which was filed Mar. 12, 2021; U.S. Provisional Patent Application No. 63/160,577, which was filed Mar. 12, 2021.

### FIELD

Various embodiments generally may relate to the field of wireless communications. For example, some embodiments may relate to initial transmission and/or retransmission of data in systems that are operating with carrier frequencies above approximately 52.6 gigahertz (GHz).

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts an example signal generation procedure for a two-port uplink control information (UCI) scenario, in accordance with various embodiments.

FIG. 2 depicts an example comb-based two port transmission scheme, in accordance with various embodiments.

FIG. 3 depicts an example of a mixed initial transmission and retransmission on a physical downlink shared channel (PDSCH) and/or a physical uplink shared channel (PUSCH), in accordance with various embodiments.

FIG. 4 depicts an example of use of a dedicated demodulation reference signal (DMRS) related to initial transmission and retransmission on a PDSCH and/or a PUSCH, in accordance with various embodiments.

FIG. 5 depicts an example of use of a DMRS related to UCI, initial transmission, and retransmission on a PDSCH and/or a PUSCH, in accordance with various embodiments.

FIG. 6 depicts an example of use of a shared DMRS for UCI and initial transmission with a same modulation order, in accordance with various embodiments.

FIG. 7 depicts an example of use of a shared DMRS for UCI and retransmission with a same modulation order, in accordance with various embodiments.

FIG. 8 depicts use of a shared DMRS for use with a UCI, initial transmission, and retransmission on a PUSCH, in accordance with various embodiments.

FIG. 9 depicts an example technique related to mixed initial transmission and retransmission of data channels, in accordance with various embodiments.

FIG. 10 depicts an alternative example technique related to mixed initial transmission and retransmission of data channels, in accordance with various embodiments.

FIG. 11 depicts an example technique related to transmission of uplink control information (UCI), in accordance with various embodiments.

FIG. 12 depicts an alternative example technique related to transmission of uplink control information (UCI), in accordance with various embodiments.

FIG. 13 schematically illustrates a wireless network in accordance with various embodiments.

FIG. 14 schematically illustrates components of a wireless network in accordance with various embodiments.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein.

### BACKGROUND

Various embodiments generally may relate to the field of wireless communications.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to current highly sophisticated integrated communication platform. The next generation wireless communication system, which may be referred to herein as fifth generation (5G) or new radio (NR), will provide access to information and sharing of data anywhere, anytime by various users and applications. NR may be a unified network/system that target to meet vastly different and sometime conflicting performance dimensions and services. Such diverse multi-dimensional requirements may be driven by different services and applications. In general, NR may evolve based on third generation partnership project (3GPP) long term evolution (LTE)-Advanced with additional potential new Radio Access Technologies (RATs) to enrich people lives with better, simple and seamless wireless connectivity solutions. NR may enable connections by wireless and deliver fast, rich contents and services. Some embodiments herein may refer to an enhanced transmission scheme for UCI. Some embodiments may additionally or alternatively relate to mixed initial transmission and retransmission of data channels for higher carrier frequencies.

Enhanced transmission scheme for UCI

In NR Release-15 (Rel-15), short physical uplink control channel (PUCCH) (PUCCH format 0 and 2) transmissions may span 1 or 2 symbols, and long PUCCH (PUCCH format 1, 3 and 4) transmissions may span from 4 to 14 symbols within a slot. Further, long PUCCH transmissions may span multiple slots to further enhance the coverage. In addition, for a given UE, two short PUCCHs transmissions as well as a short PUCCH transmissions and a long PUCCH transmission may be multiplexed in a time division multiplexing (TDM) manner in a same slot. Further, single port transmission may be applied for all different PUCCH formats.

Note that uplink control information (UCI) may be carried by the PUCCH or the PUSCH. In particular, the UCI may include information or indications related to one or more of the following: scheduling request (SR), hybrid automatic repeat request—acknowledgement (HARQ-ACK) feedback, channel state information (CSI) report, e.g., channel quality indicator (CQI), pre-coding matrix indicator (PMI), CSI resource indicator (CRI) and rank indicator (RI) and/or beam related information (e.g., layer 1—reference signal received power (L1-RSRP)).

For cellular systems, coverage may be an important factor for successful operation. Compared to LTE, NR may be deployed at higher carrier frequency, e.g., in frequency range 2 (FR2) at the millimeter-wave (mmWave) frequency band. In some embodiments, FR2 may refer to a frequency range between approximately 24.6 GHz and approximately 71 GHz. In this case, coverage loss may occur due to larger path-loss, which may make it more challenging to maintain an adequate quality of service. Typically, uplink coverage is the bottleneck for system operation considering the low transmit power at the user equipment (UE)-side.

For systems operating above the approximately 52.6 GHz carrier frequency, and/or sixth generation (6G) communication systems, it may be more desirable to improve the coverage for UCI transmission on the PUCCH or the PUSCH, especially in cases where the UE is equipped with multiple transmit antennas. In this case, multiple port transmission may be employed for UCI transmission on PUCCH or PUSCH to exploit the benefit of transmit diversity or spatial diversity. To support multiple port transmission for UCI transmission on PUCCH or PUSCH, certain design changes to legacy 3GPP specifications may be desired. Various embodiments herein include systems and methods of enhanced transmission scheme for UCI on PUSCH.

In one embodiment, when multiple port-based transmission is applied for UCI, separate coding may be applied for UCI on each port. Further, the same coding with same or different scrambling may be used for the UCI transmission on different port. Note that this coding scheme may be applied for UCI transmission on PUCCH or PUSCH.

When different scrambling sequences are applied for the UCI transmission on each port, a fixed offset may be used for the scrambling sequence initialization between two ports for UCI transmission.

In one example, the scrambling sequence generator for UCI transmission on a first port may be initialized with

cᵢₙᵢₜ=n_{RNTI}·2¹⁵+n_{ID}

Where n_{RNTI} is the Radio Network Temporary Identifier (RNTI) for UCI transmission, which can be a cell-RNTI (C-RNTI) and/or a temporary C-RNTI (TC-RNTI). n_{ID} may be configured by higher layers via minimum system information (MSI), remaining minimum system information (RMSI) (e.g., system information block 1 (SIB1)), other system information (OSI), and/or radio resource control (RRC) signalling and, if not configured, n_{ID} may be the physical cell ID. Further, the scrambling sequence generator for UCI transmission on a second port may be initialized with

cᵢₙᵢₜ=n_{RNTI}·2¹⁵+n_{ID}+Δ

Where Δ may be predefined in the specification. For example, in some embodiments Δ may be equal to 1.

In another embodiment, block-wised orthogonal cover code (OCC) may be applied for the modulated symbols prior to discrete fourier transform (DFT) operation for multiple port UCI transmission on PUSCH.

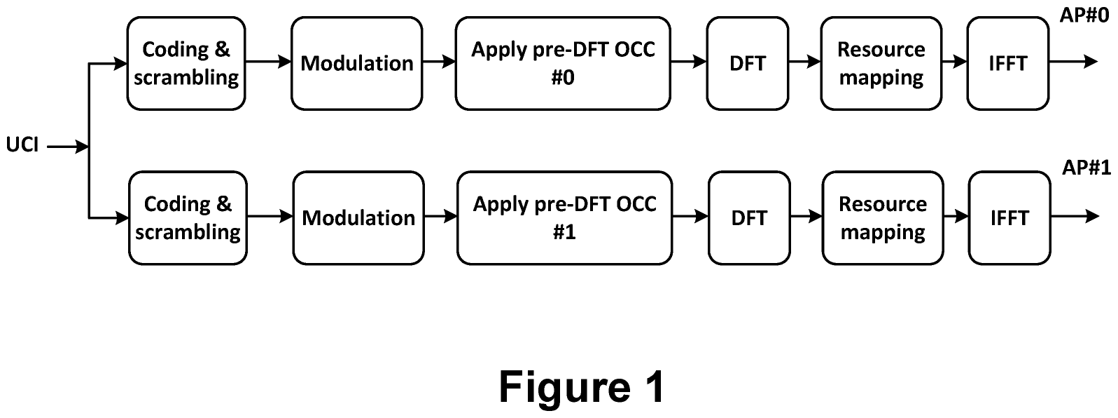

FIG. 1 illustrates an example procedure for signal generation for two port UCI transmission scheme. In particular, UCI is coded and modulated in each antenna port (AP), as indicated by the branching pathways from the UCI input. Specifically, one pathway corresponds to AP #0, and another pathway corresponds to AP #1. As mentioned above, the same coding with same or different scrambling can be used for the UCI transmission on each AP. Subsequently, block-wised spreading with OCC is performed on the modulated symbols. After that, spread modulated symbols are input to the DFT block, mapped to the allocated resource in the frequency domain as the input to the inverse fast fourier transform (IFFT) block, and then converted into time domain signal for each AP, AP #0 and AP #1.

In one example, the block-wised spreading operation for the modulated symbols prior to DFT is given by

$${y}^{( {n}_{A P} )} ( l {M}_{S C} + k ) = {w}_{{n}_{A P}} ( ⌊ k \frac{{N}_{S F}}{{M}_{S C}} ⌋ ) d ( l \frac{{M}_{S C}}{{N}_{S F}} + k mod \frac{{M}_{S C}}{{N}_{S F}} )$$

$$k = 0 , 1 , … , {M}_{S C} - 1$$

$$l = 0 , 1 , … , ( {N}_{S F} {M}_{s y m b} / {M}_{S C} ) - 1$$

Where N_{SF} is the spreading factor, M_{SC} is the number of subcarriers for UCI transmission, M_{symb} is the number of symbols for UCI transmission, and Wₙ_{_{AP}} is the OCC code for nap port, which is given in Table 1, below. For two port transmission, N_{SF}=2.

TABLE 1
wₙ_{_{AP}}for two port UCI transmission

| n_{AP} | wₙ_{_{AP}} |
|---|---|
| 0 | [+1 +1] |
| 1 | [+1 −1] |

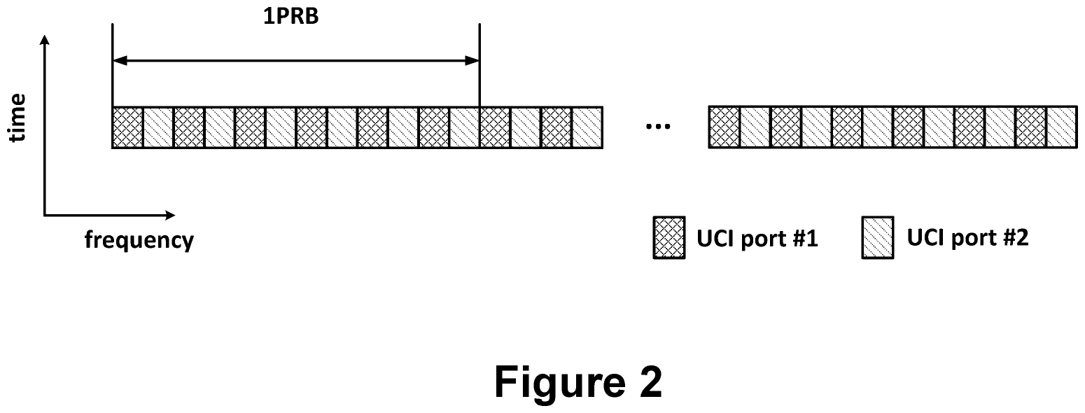

In another embodiment, modulated symbols after DFT operation may be directly mapped to different combs for different ports for UCI transmission. As used herein, a “comb” refers to the use of different subcarriers in the frequency domain for different ports. In one example, even subcarrier may be allocated for a UCI port #1, as indicated by the cross-hatched subcarriers of FIG. 2, while odd subcarrier may be allocated for a UCI port #2, as indicated by the diagonally-hatched subcarriers of FIG. 2.

In another embodiment, when pre-DFT blocked-wised OCC is applied for UCI transmission on PUSCH, OCC index may be configured by higher layers via MSI, RMSI (SIB1), OSI, and/or RRC signalling, or dynamically indicated in the DCI, or a combination thereof.

Similarly, when UCI is mapped to different combs for multiple port transmission, comb index may be configured by higher layers via MSI, RMSI (SIB1), OSI or RRC signalling or dynamically indicated in the DCI or a combination thereof.

In another embodiment, when shared DMRS is applied for the transmission of UCI and uplink shared channel (UL-SCH) on PUSCH, comb index or OCC index on each port for UCI transmission on PUSCH can be determined in accordance with the DMRS antenna port (AP) index for PUSCH transmission.

In this case, DMRS AP for PUSCH transmission may be first determined in accordance with the indication in the DCI, and further the comb index or OCC index of UCI on PUSCH for each AP can be determined in accordance with the DMRS AP index.

In one option, when two-port transmission is applied for UCI on PUSCH, comb index of 0 or OCC index of 0 is associated with the smaller indicated DMRS AP, while comb index of 1 or OCC index of 1 is associated with the larger indicated DMRS AP for PUSCH transmission.

Table 2 illustrates one example of comb or OCC index for two port UCI transmission from DMRS AP index for PUSCH. In the example, p₀ is the first or smaller DMRS AP within two indicated DMRS APs; while p₁ is the second or larger DMRS AP within the two indicated DMRS APs for PUSCH transmission.

TABLE 2
Comb or OCC index from DMRS AP index

| Comb or OCC index | DMRS AP index |
|---|---|
| 0 | p₀ |
| 1 | p₁ |

Initial Transmission and Retransmission of Data Channels for Higher Carrier Frequencies

In NR Release 15, system design is targeted for carrier frequencies up to 52.6 GHz with a waveform choice of cyclic prefix—orthogonal frequency-division multiplexing (CP-OFDM) for downlink (DL) and uplink (UL), and additionally, Discrete Fourier Transform-spread-OFDM (DFT-s-OFDM) for UL. However, for carrier frequencies at or above approximately 52.6 GHz, a single carrier based waveform may be used in order to handle issues including low power amplifier (PA) efficiency and large phase noise.

For a single carrier based waveform, DFT-s-OFDM may be considered for both DL and UL. For an OFDM-based transmission scheme including DFT-s-OFDM, a cyclic prefix (CP) may be inserted at the beginning of each block, where the last data symbols in a block are repeated as the CP. Typically, the length of CP may exceed the maximum expected delay spread in order to overcome the inter-symbol interference (ISI).

Further, for systems operating at or above the 52.6 GHz carrier frequency, or 6G communication systems, a relatively large number of TBs may be scheduled by a single DCI for PDSCH and PUSCH transmissions. If some of the TBs are not received successfully at the receiver, the transmitter may need to retransmit the failed TBs. Meanwhile, if the transmitter has some new packets that need to be transmitted, the transmitter may combine the initial transmission of some TBs and retransmission of failed TBs in a single PDSCH or PUSCH.

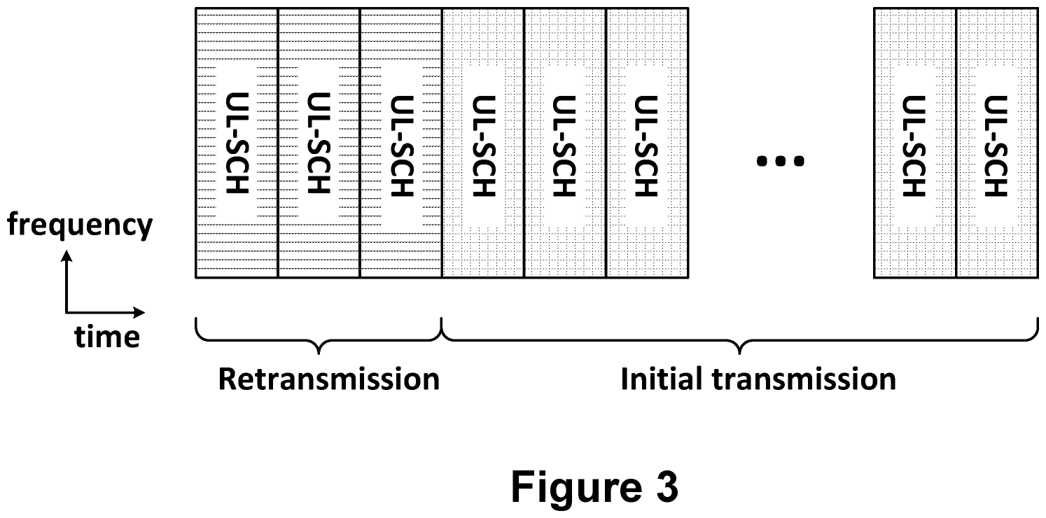

FIG. 3 illustrates one example of mixed initial transmission (e.g., the blocks with linear shading) and retransmission (e.g., the blocks with gridded cross-shading) for PDSCH and PUSCH. Note that although in the example, retransmission of TBs is located before initial transmission of TBs, embodiments herein may include the case when initial transmission is located before retransmission of the TBs.

It will be noted that FIG. 3, and other Figures herein, are intended as example Figures for the purpose of discussion. Specific shading patterns may be used differently in different Figures, unless explicitly indicated otherwise. In other words, a shading pattern used in one of FIGS. 3-8 may represent a different concept than the same shading pattern used in another of FIGS. 3-8.

For the mixed initial transmission and retransmission in a PDSCH or PUSCH, a 5G base station (gNB) may schedule different modulation orders for initial transmission and retransmission of TBs. In this case, it may be difficult for the transmitter to maintain phase continuity between initial transmission and retransmission, especially from the UE perspective. This may also result in different transmit powers between initial transmission and retransmission of TBs. To address this issue, certain mechanisms be desired for the mixed initial transmission and retransmission for PDSCH and PUSCH.

Various embodiments herein provide mechanisms for mixed initial transmission and retransmission of data channel for higher carrier frequency. Specifically, embodiments for mixed initial transmission and retransmission of data channel may include one or more of the following:

In one embodiment, when different modulation orders are used for the initial transmission and retransmission of the TBs on PUSCH and PDSCH, dedicated DMRS(s) may be allocated for the initial transmission and retransmission of the TBs, respectively. In this case, decoding of retransmission of TBs and initial transmission of TBs may be based on DMRS for retransmission and initial transmission of the TBs, respectively. In some embodiments, the modulation orders for initial and retransmission of the TBs may be explicitly indicated in the DCI.

Further, if different transmit powers are used for the transmission of retransmission and initial transmission of TBs, depending on UE capability, a time gap may be inserted between transmission of retransmission and initial transmission of TBs on PUSCH. Note that the time gap may be defined on the basis of symbol or symbol group. In particular, a number of symbols for a time gap within the PDSCH or PUSCH transmission may be configured by higher layers via MSI, MSI, OSI, and/or dedicated RRC signalling, or dynamically indicated in the DCI or a combination thereof. The number of symbols for the time gap may be reported by UE as UE capability.

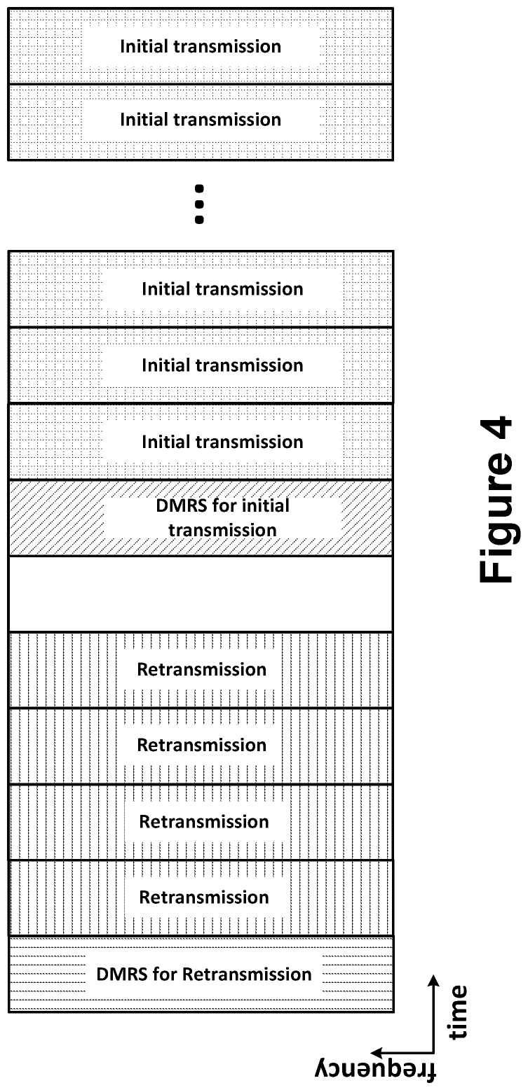

FIG. 4 illustrates one example of dedicated DMRS for initial transmission (e.g., the diagonally shaded block) and retransmission (e.g., the vertically shaded block) on PUSCH and PDSCH. In the example, DMRS for retransmission is transmitted before retransmission of TB(s) on PUSCH (e.g., the horizontally shaded blocks) and DMRS for initial transmission is transmitted before initial transmission (e.g., the grid-shaded blocks) of TB(s) on PDSCH or PUSCH. Note that, depending on the duration of initial and retransmission of the TBs, additional DMRS symbol(s) may be inserted within the retransmission and initial transmission of the TBs on PDSCH or PUSCH. Further, a 1-symbol gap may be inserted between initial and retransmission of the TBs, which is reserved for power transition.

In another embodiment, when UCI is multiplexed on PUSCH, and if different modulation orders are used for the transmission of UCI, retransmission and initial transmission of TBs, dedicated DMRS(s) are allocated for the UCI, initial transmission and retransmission of the TBs, respectively. Further, depending on UE capability, if different transmit powers are used for the transmission of UCI, retransmission and initial transmission of TBs, a time gap may be inserted between transmission of UCI, retransmission and initial transmission of TBs on PUSCH. Note that the modulation order for UCI may be predefined in the specification or equal to the modulation order for the initial or retransmission of the TBs on PUSCH, which may be explicitly indicated in the DCI as mentioned above.

Note that UCI may include one or more of the following: scheduling request (SR), hybrid automatic repeat request—acknowledgement (HARQ-ACK) feedback, channel state information (CSI) report, e.g., channel quality indicator (CQI), pre-coding matrix indicator (PMI), CSI resource indicator (CRI) and rank indicator (RI) and/or beam related information (e.g., L1-RSRP (layer 1—reference signal received power)).

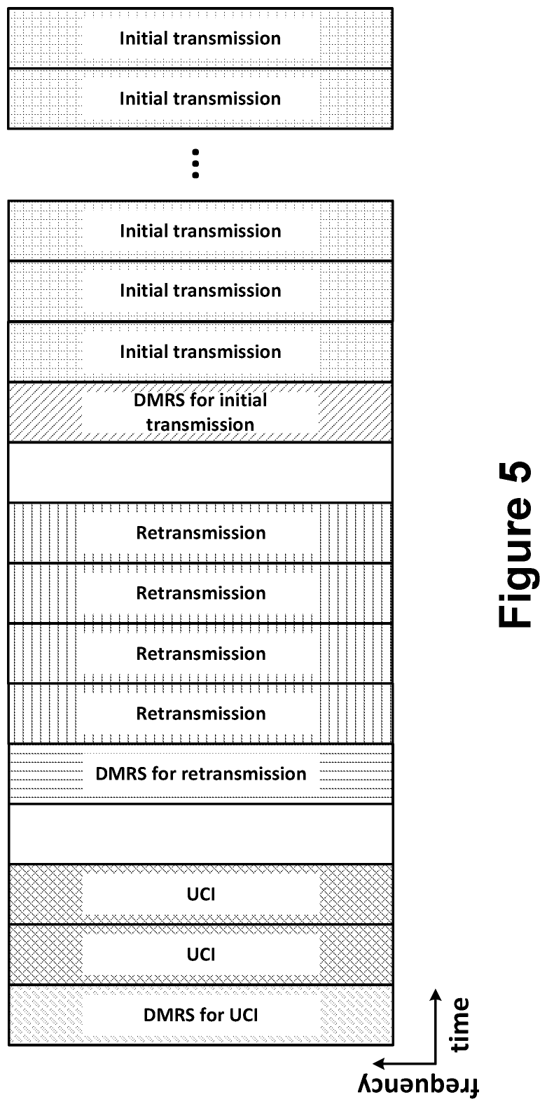

FIG. 5 illustrates one example of dedicated DMRS for UCI (e.g., as indicated by the diagonally-shaded block that rises from left-to-right), DMRS for initial transmission (as indicated by the vertically-shaded block), and DMRS for retransmission (as indicated by the diagonally-shaded block that falls from left-to-right) on PUSCH. In the example, DMRS for UCI is transmitted before the UCI (indicated by the cross-hatched blocks) on PUSCH, DMRS for retransmission is transmitted before retransmission (as indicated by the horizontally-shaded blocks) of TB(s) on PUSCH, and DMRS for initial transmission is transmitted before initial transmission (indicated by the grid-shaded blocks) of TB(s) on PUSCH. Further, a 1 symbol gap is inserted between UCI, initial and retransmission of the TBs, which is reserved for power transition.

In another embodiment, a same modulation order may be used for the transmission of UCI and initial transmission or retransmission of TBs on PUSCH. When the same modulation order is employed for the transmission of UCI and initial transmission of TBs on PUSCH or the transmission of the UCI and retransmission, a shared DMRS may be used for the transmission of UCI and initial transmission or the transmission of UCI and retransmission, respectively.

Further, when same modulation order is used for the transmission of UCI and initial transmission on PUSCH, UCI may be mapped before the initial transmission and shared DMRS may be allocated before the UCI. A time gap may be inserted between retransmission and UCI on PUSCH for power transition as mentioned above.

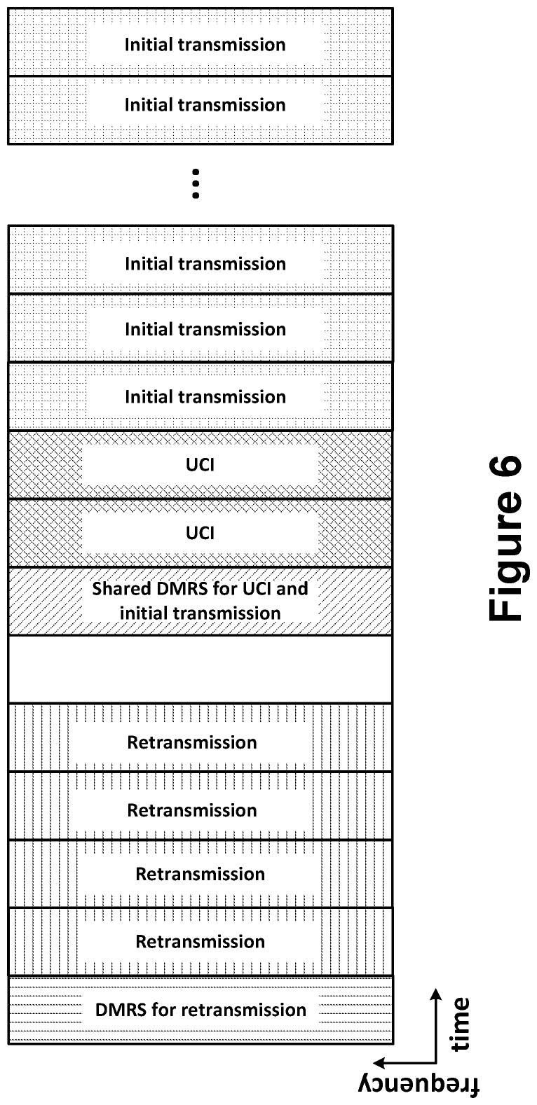

FIG. 6 illustrates one example of a shared DMRS for UCI and initial transmission (as indicated by the diagonally-shaded block that falls from left-to right) with same modulation order. In the example, different modulation orders are used for retransmission and UCI/initial transmission on PUSCH. In this case, DMRS for retransmission (as indicated by the block with vertical shading) is transmitted before retransmission (as indicated by the blocks with horizontal shading) of TB(s) on PUSCH and shared DMRS for UCI and initial transmission is transmitted before the UCI (as indicated by the blocks with cross-hatch shading) on PUSCH. Further, a 1 symbol gap is inserted between retransmission and UCI, which is reserved for power transition.

Similarly, if same modulation order is used for the transmission of UCI and retransmission on PUSCH, UCI may be mapped before the retransmission and shared DMRS is allocated before the UCI. A time gap may be inserted between retransmission and initial on PUSCH for power transition as mentioned above.

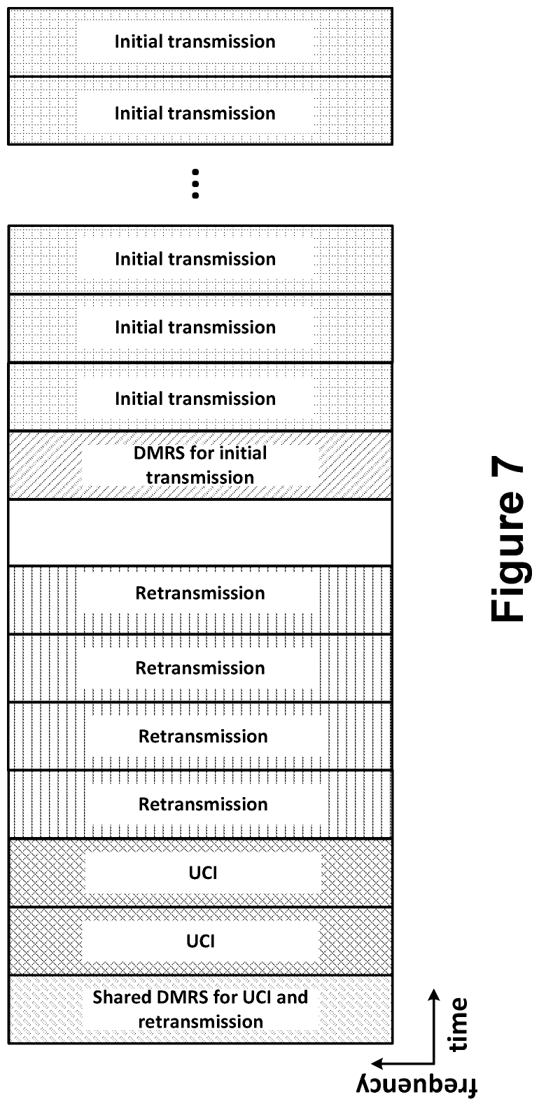

FIG. 7 illustrates one example of use of a shared DMRS for UCI and retransmission (as indicated by the block with the diagonal shading that rises from left to right) with same modulation order. In the example, different modulation orders are used for initial transmission (indicated by the blocks with gridded shading) and UCI/retransmission (as indicated by the blocks with cross-hatch shading and the blocks with horizontal shading, respectively) on PUSCH. In this case, DMRS for initial transmission (as indicated by the block with diagonal shading that falls from left-to-right) is transmitted before initial transmission of TB(s) on PUSCH and shared DMRS for UCI and retransmission is transmitted before the UCI on PUSCH. Further, a 1 symbol gap is inserted between retransmission and initial transmission, which is reserved for power transition.

In another embodiment, the same modulation order may always applied for the initial transmission, retransmission and/or UCI. In this case, indication of modulation order or modulation and coding scheme (MCS) for the retransmission of the TBs on PDSCH or PUSCH is not included in the DCI. In addition, modulation order offset or MCS offset between first transmission and retransmission may not be included in the DCI.

When same modulation orders are used for the transmission of UCI, initial and retransmission of TB(s) on PUSCH, shared DMRS may be used for UCI, initial and retransmission of the TBs on PUSCH, which can be transmitted before the UCI. In this case, time gap may not be needed during PUSCH transmission.

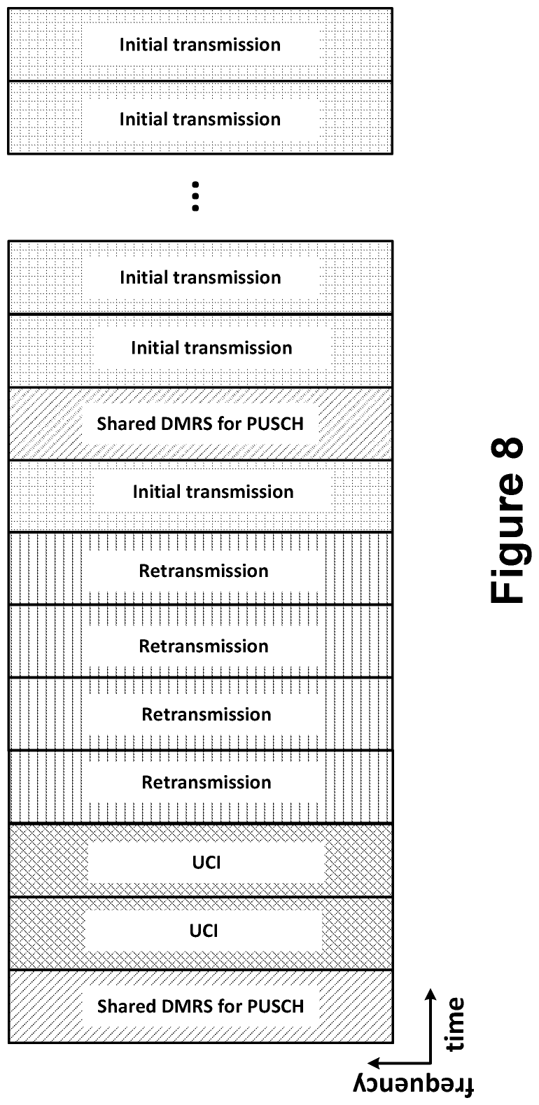

FIG. 8 illustrates one example of shared DMRS (as indicated by the blocks with diagonal shading) for UCI, initial transmission and retransmission on PUSCH. In the example, UCI (indicated by the blocks with cross-hatch shading) is transmitted before retransmission (indicated by the blocks with horizontal shading) of the TBs and followed by initial transmission (as indicated by the blocks with gridded shading) of the TBs on PUSCH. As mentioned above, depending on the length of PUSCH transmission, additional DMRS symbol(s) may be inserted.

Note that other permutations of the mapping order of UCI, retransmission and initial transmission may be additionally or alternatively derived in other embodiments herein.

In another embodiment, when different transmit power is applied for the transmission of initial transmission, retransmission and/or UCI, a shared DMRS may be used. In this case, transmit power difference or transmit power ratio between initial transmission, retransmission and/or UCI may be configured by higher layers via MSI, RMSI (e.g., SIB1), OSI or RRC signalling or dynamically indicated in the DCI or a combination thereof. In this case, the receiver can derive the power difference between the DMRS symbols and initial transmission, retransmission and/or UCI.

In another embodiment, different frequency domain resource allocation (FDRA) can be allocated for the initial and retransmission of TB(s) on PDSCH or PUSCH. In this case, two FDRA fields can be inserted in the DCI to indicate the frequency domain resource for the initial and retransmission of TB(s) on PDSCH or PUSCH, respectively. Alternatively, same starting PRBs but different length of PRBs or PRB size difference can be used for the transmission of the initial and retransmission of TB(s) on PDSCH or PUSCH.

Further, when UCI is multiplexed on PUSCH, same frequency domain resource can be allocated for the UCI and initial transmission of the TB(s), or the UCI and retransmission of the TB(s) on PUSCH.

In another embodiment, separate transmit power command (TPC) fields can be included in the DCI, which is used for the transmission of the initial and retransmission of TB(s) on PUSCH, respectively. Further, when UCI is multiplexed on PUSCH, same TPC command can be used for the UCI and initial transmission of the TB(s), or the UCI and retransmission of the TB(s) on PUSCH.

As a further extension, independent transmit power processes can be applied for the transmission of initial and retransmission of TB(s) on PUSCH.

Example Techniques

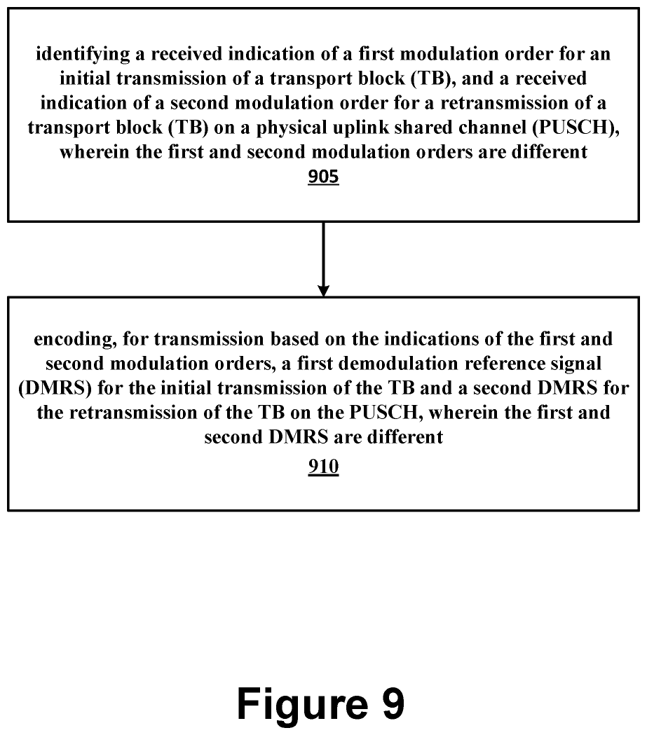

FIGS. 9-12 depicts various example techniques related to embodiments herein. It will be understood that such techniques are intended as examples of certain embodiments of the present disclosure, and other embodiments may include more or fewer elements, elements performed in a different order, different elements, etc.

FIG. 9 depicts an example technique related to mixed initial transmission and retransmission of data channels, in accordance with various embodiments. Such a technique may be performed by an electronic device that is, is part of, or includes a user equipment (UE) in a cellular network such as a fifth generation (5G) or higher cellular network. The technique may include identifying, at 905, a received indication of a first modulation order for an initial transmission of a transport block (TB), and a received indication of a second modulation order for a retransmission of a transport block (TB) on a physical uplink shared channel (PUSCH), wherein the first and second modulation orders are different; and encoding, at 910 for transmission based on the indications of the first and second modulation orders, a first demodulation reference signal (DMRS) for the initial transmission of the TB and a second DMRS for the retransmission of the TB on the PUSCH, wherein the first and second DMRS are different.

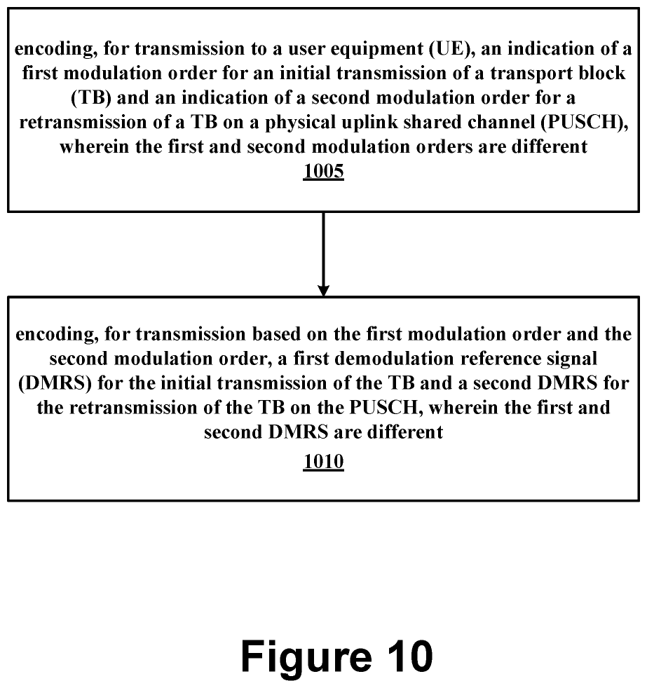

FIG. 10 depicts an alternative example technique related to mixed initial transmission and retransmission of data channels, in accordance with various embodiments. Such a technique may be performed by an electronic device that is, is part of, or includes a base station in a cellular network such as a fifth generation (5G) or higher cellular network. The technique may include encoding, at 1005 for transmission to a user equipment (UE), an indication of a first modulation order for an initial transmission of a transport block (TB) and an indication of a second modulation order for a retransmission of a TB on a physical uplink shared channel (PUSCH), wherein the first and second modulation orders are different; and encoding, at 1010 for transmission based on the first modulation order and the second modulation order, a first demodulation reference signal (DMRS) for the initial transmission of the TB and a second DMRS for the retransmission of the TB on the PUSCH, wherein the first and second DMRS are different.

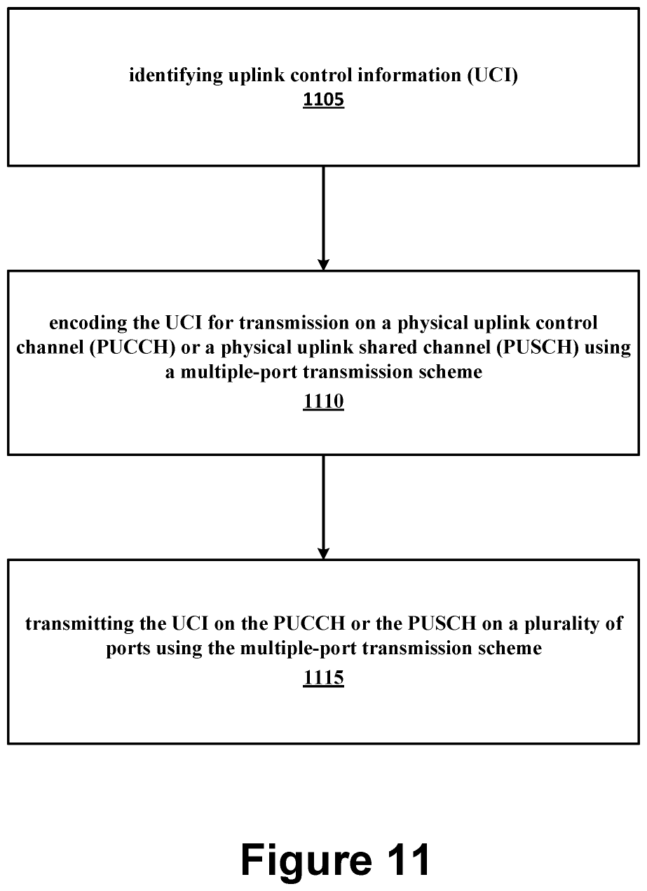

FIG. 11 depicts an example technique related to transmission of uplink control information (UCI), in accordance with various embodiments. Such a technique may be performed by an electronic device that is, is part of, or includes a user equipment (UE) in a cellular network such as a fifth generation (5G) or higher cellular network. The technique may include identifying, at 1105, uplink control information (UCI); encoding, at 1110, the UCI for transmission on a physical uplink control channel (PUCCH) or a physical uplink shared channel (PUSCH) using a multiple-port transmission scheme; and transmitting, at 1115, the UCI on the PUCCH or the PUSCH on a plurality of ports using the multiple-port transmission scheme.

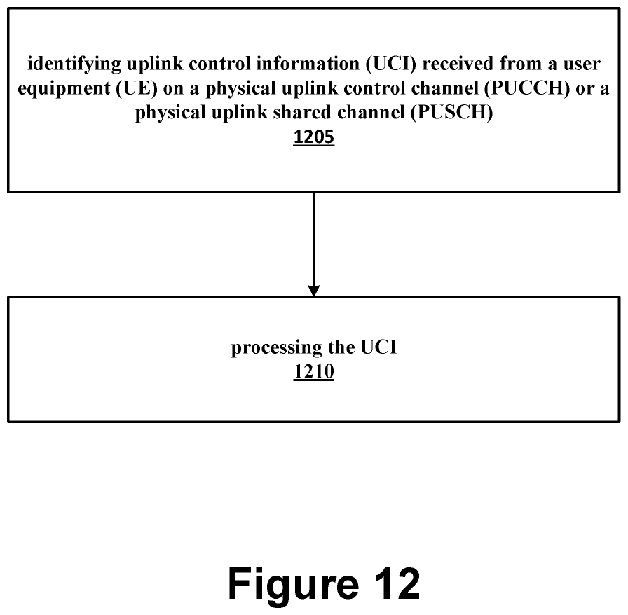

FIG. 12 depicts an alternative example technique related to transmission of uplink control information (UCI), in accordance with various embodiments. Such a technique may be performed by an electronic device that is, is part of, or includes a base station in a cellular network such as a fifth generation (5G) or higher cellular network. The technique may include identifying, at 1205, uplink control information (UCI) received from a user equipment (UE) on a physical uplink control channel (PUCCH) or a physical uplink shared channel (PUSCH); and processing, at 1210, the UCI. In embodiments, the UCI may have been transmitted by the UE on a the PUCCH or the PUSCH on a plurality of ports using the multiple-port transmission scheme.

Systems and Implementations

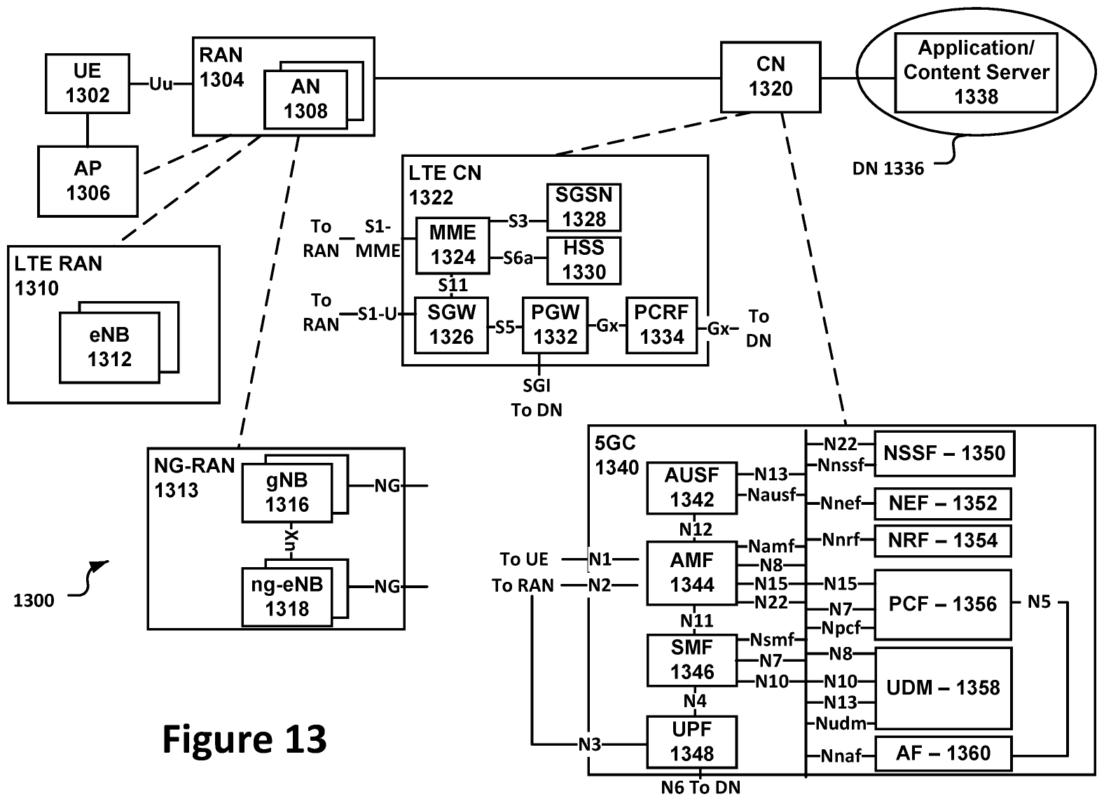

FIGS. 13-15 illustrate various systems, devices, and components that may implement aspects of disclosed embodiments.

FIG. 13 illustrates a network 1300 in accordance with various embodiments. The network 1300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1300 may include a UE 1302, which may include any mobile or non-mobile computing device designed to communicate with a RAN 1304 via an over-the-air connection. The UE 1302 may be communicatively coupled with the RAN 1304 by a Uu interface. The UE 1302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1302 may additionally communicate with an AP 1306 via an over-the-air connection. The AP 1306 may manage a WLAN connection, which may serve to offload some/all network traffic from the RAN 1304. The connection between the UE 1302 and the AP 1306 may be consistent with any IEEE 802.11 protocol, wherein the AP 1306 could be a wireless fidelity (Wi-Fi®) router. In some embodiments, the UE 1302, RAN 1304, and AP 1306 may utilize cellular-WLAN aggregation (for example, LWA/LWIP). Cellular-WLAN aggregation may involve the UE 1302 being configured by the RAN 1304 to utilize both cellular radio resources and WLAN resources.

The RAN 1304 may include one or more access nodes, for example, AN 1308. AN 1308 may terminate air-interface protocols for the UE 1302 by providing access stratum protocols including RRC, PDCP, RLC, MAC, and L1 protocols. In this manner, the AN 1308 may enable data/voice connectivity between CN 1320 and the UE 1302. In some embodiments, the AN 1308 may be implemented in a discrete device or as one or more software entities running on server computers as part of, for example, a virtual network, which may be referred to as a CRAN or virtual baseband unit pool. The AN 1308 be referred to as a BS, gNB, RAN node, eNB, ng-eNB, NodeB, RSU, TRxP, TRP, etc. The AN 1308 may be a macrocell base station or a low power base station for providing femtocells, picocells or other like cells having smaller coverage areas, smaller user capacity, or higher bandwidth compared to macrocells.

In embodiments in which the RAN 1304 includes a plurality of ANs, they may be coupled with one another via an X2 interface (if the RAN 1304 is an LTE RAN) or an Xn interface (if the RAN 1304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1304 may each manage one or more cells, cell groups, component carriers, etc. to provide the UE 1302 with an air interface for network access. The UE 1302 may be simultaneously connected with a plurality of cells provided by the same or different ANs of the RAN 1304. For example, the UE 1302 and RAN 1304 may use carrier aggregation to allow the UE 1302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1302 or AN 1308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1304 may be an LTE RAN 1310 with eNBs, for example, eNB 1312. The LTE RAN 1310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1304 may be an NG-RAN 1314 with gNBs, for example, gNB 1316, or ng-eNBs, for example, ng-eNB 1318. The gNB 1316 may connect with 5G-enabled UEs using a 5G NR interface. The gNB 1316 may connect with a 5G core through an NG interface, which may include an N2 interface or an N3 interface. The ng-eNB 1318 may also connect with the 5G core through an NG interface, but may connect with a UE via an LTE air interface. The gNB 1316 and the ng-eNB 1318 may connect with each other over an Xn interface.

In some embodiments, the NG interface may be split into two parts, an NG user plane (NG-U) interface, which carries traffic data between the nodes of the NG-RAN 1314 and a UPF 1348 (e.g., N3 interface), and an NG control plane (NG-C) interface, which is a signaling interface between the nodes of the NG-RAN1314 and an AMF 1344 (e.g., N2 interface).

The NG-RAN 1314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1302 can be configured with multiple BWPs where each BWP configuration has a different SCS. When a BWP change is indicated to the UE 1302, the SCS of the transmission is changed as well. Another use case example of BWP is related to power saving. In particular, multiple BWPs can be configured for the UE 1302 with different amount of frequency resources (for example, PRBs) to support data transmission under different traffic loading scenarios. A BWP containing a smaller number of PRBs can be used for data transmission with small traffic load while allowing power saving at the UE 1302 and in some cases at the gNB 1316. A BWP containing a larger number of PRBs can be used for scenarios with higher traffic load.

The RAN 1304 is communicatively coupled to CN 1320 that includes network elements to provide various functions to support data and telecommunications services to customers/subscribers (for example, users of UE 1302). The components of the CN 1320 may be implemented in one physical node or separate physical nodes. In some embodiments, NFV may be utilized to virtualize any or all of the functions provided by the network elements of the CN 1320 onto physical compute/storage resources in servers, switches, etc. A logical instantiation of the CN 1320 may be referred to as a network slice, and a logical instantiation of a portion of the CN 1320 may be referred to as a network sub-slice.

In some embodiments, the CN 1320 may be an LTE CN 1322, which may also be referred to as an EPC. The LTE CN 1322 may include MME 1324, SGW 1326, SGSN 1328, HSS 1330, PGW 1332, and PCRF 1334 coupled with one another over interfaces (or “reference points”) as shown. Functions of the elements of the LTE CN 1322 may be briefly introduced as follows.

The MME 1324 may implement mobility management functions to track a current location of the UE 1302 to facilitate paging, bearer activation/deactivation, handovers, gateway selection, authentication, etc.

The SGW 1326 may terminate an SI interface toward the RAN and route data packets between the RAN and the LTE CN 1322. The SGW 1326 may be a local mobility anchor point for inter-RAN node handovers and also may provide an anchor for inter-3GPP mobility. Other responsibilities may include lawful intercept, charging, and some policy enforcement.

The SGSN 1328 may track a location of the UE 1302 and perform security functions and access control. In addition, the SGSN 1328 may perform inter-EPC node signaling for mobility between different RAT networks; PDN and S-GW selection as specified by MME 1324; MME selection for handovers; etc. The S3 reference point between the MME 1324 and the SGSN 1328 may enable user and bearer information exchange for inter-3GPP access network mobility in idle/active states.

The HSS 1330 may include a database for network users, including subscription-related information to support the network entities' handling of communication sessions. The HSS 1330 can provide support for routing/roaming, authentication, authorization, naming/addressing resolution, location dependencies, etc. An S6a reference point between the HSS 1330 and the MME 1324 may enable transfer of subscription and authentication data for authenticating/authorizing user access to the LTE CN 1320.

The PGW 1332 may terminate an SGi interface toward a data network (DN) 1336 that may include an application/content server 1338. The PGW 1332 may route data packets between the LTE CN 1322 and the data network 1336. The PGW 1332 may be coupled with the SGW 1326 by an S5 reference point to facilitate user plane tunneling and tunnel management. The PGW 1332 may further include a node for policy enforcement and charging data collection (for example, PCEF). Additionally, the SGi reference point between the PGW 1332 and the data network 13 36 may be an operator external public, a private PDN, or an intra-operator packet data network, for example, for provision of IMS services. The PGW 1332 may be coupled with a PCRF 1334 via a Gx reference point.

The PCRF 1334 is the policy and charging control element of the LTE CN 1322. The PCRF 1334 may be communicatively coupled to the app/content server 1338 to determine appropriate QoS and charging parameters for service flows. The PCRF 1332 may provision associated rules into a PCEF (via Gx reference point) with appropriate TFT and QCI.

In some embodiments, the CN 1320 may be a 5GC 1340. The 5GC 1340 may include an AUSF 1342, AMF 1344, SMF 1346, UPF 1348, NSSF 1350, NEF 1352, NRF 1354, PCF 1356, UDM 1358, and AF 1360 coupled with one another over interfaces (or “reference points”) as shown. Functions of the elements of the 5GC 1340 may be briefly introduced as follows.

The AUSF 1342 may store data for authentication of UE 1302 and handle authentication-related functionality. The AUSF 1342 may facilitate a common authentication framework for various access types. In addition to communicating with other elements of the 5GC 1340 over reference points as shown, the AUSF 1342 may exhibit an Nausf service-based interface.

The AMF 1344 may allow other functions of the 5GC 1340 to communicate with the UE 1302 and the RAN 1304 and to subscribe to notifications about mobility events with respect to the UE 1302. The AMF 1344 may be responsible for registration management (for example, for registering UE 1302), connection management, reachability management, mobility management, lawful interception of AMF-related events, and access authentication and authorization. The AMF 1344 may provide transport for SM messages between the UE 1302 and the SMF 1346, and act as a transparent proxy for routing SM messages. AMF 1344 may also provide transport for SMS messages between UE 1302 and an SMSF. AMF 1344 may interact with the AUSF 1342 and the UE 1302 to perform various security anchor and context management functions. Furthermore, AMF 1344 may be a termination point of a RAN CP interface, which may include or be an N2 reference point between the RAN 1304 and the AMF 1344; and the AMF 1344 may be a termination point of NAS (N1) signaling, and perform NAS ciphering and integrity protection. AMF 1344 may also support NAS signaling with the UE 1302 over an N3 IWF interface.

The SMF 1346 may be responsible for SM (for example, session establishment, tunnel management between UPF 1348 and AN 1308); UE IP address allocation and management (including optional authorization); selection and control of UP function; configuring traffic steering at UPF 1348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1344 over N2 to AN 1308; and determining SSC mode of a session. SM may refer to management of a PDU session, and a PDU session or “session” may refer to a PDU connectivity service that provides or enables the exchange of PDUs between the UE 1302 and the data network 1336.

The UPF 1348 may act as an anchor point for intra-RAT and inter-RAT mobility, an external PDU session point of interconnect to data network 1336, and a branching point to support multi-homed PDU session. The UPF 1348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1348 may include an uplink classifier to support routing traffic flows to a data network.

The NSSF 1350 may select a set of network slice instances serving the UE 1302. The NSSF 1350 may also determine allowed NSSAI and the mapping to the subscribed S-NSSAIs, if needed. The NSSF 1350 may also determine the AMF set to be used to serve the UE 1302, or a list of candidate AMFs based on a suitable configuration and possibly by querying the NRF 1354. The selection of a set of network slice instances for the UE 1302 may be triggered by the AMF 1344 with which the UE 1302 is registered by interacting with the NSSF 1350, which may lead to a change of AMF. The NSSF 1350 may interact with the AMF 1344 via an N22 reference point; and may communicate with another NSSF in a visited network via an N31 reference point (not shown). Additionally, the NSSF 1350 may exhibit an Nnssf service-based interface.

The NEF 1352 may securely expose services and capabilities provided by 3GPP network functions for third party, internal exposure/re-exposure, AFs (e.g., AF 1360), edge computing or fog computing systems, etc. In such embodiments, the NEF 1352 may authenticate, authorize, or throttle the AFs. NEF 1352 may also translate information exchanged with the AF 1360 and information exchanged with internal network functions. For example, the NEF 1352 may translate between an AF-Service-Identifier and an internal 5GC information. NEF 1352 may also receive information from other NFs based on exposed capabilities of other NFs. This information may be stored at the NEF 1352 as structured data, or at a data storage NF using standardized interfaces. The stored information can then be re-exposed by the NEF 1352 to other NFs and AFs, or used for other purposes such as analytics. Additionally, the NEF 1352 may exhibit an Nnef service-based interface.

The NRF 1354 may support service discovery functions, receive NF discovery requests from NF instances, and provide the information of the discovered NF instances to the NF instances. NRF 1354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1354 may exhibit the Nnrf service-based interface.

The PCF 1356 may provide policy rules to control plane functions to enforce them, and may also support unified policy framework to govern network behavior. The PCF 1356 may also implement a front end to access subscription information relevant for policy decisions in a UDR of the UDM 1358. In addition to communicating with functions over reference points as shown, the PCF 1356 exhibit an Npcf service-based interface.

The UDM 1358 may handle subscription-related information to support the network entities' handling of communication sessions, and may store subscription data of UE 1302. For example, subscription data may be communicated via an N8 reference point between the UDM 1358 and the AMF 1344. The UDM 1358 may include two parts, an application front end and a UDR. The UDR may store subscription data and policy data for the UDM 1358 and the PCF 1356, and/or structured data for exposure and application data (including PFDs for application detection, application request information for multiple UEs 1302) for the NEF 1352. The Nudr service-based interface may be exhibited by the UDR 221 to allow the UDM 1358, PCF 1356, and NEF 1352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1358 may exhibit the Nudm service-based interface.

The AF 1360 may provide application influence on traffic routing, provide access to NEF, and interact with the policy framework for policy control.

In some embodiments, the 5GC 1340 may enable edge computing by selecting operator/3rd party services to be geographically close to a point that the UE 1302 is attached to the network. This may reduce latency and load on the network. To provide edge-computing implementations, the 5GC 1340 may select a UPF 1348 close to the UE 1302 and execute traffic steering from the UPF 1348 to data network 1336 via the N6 interface. This may be based on the UE subscription data, UE location, and information provided by the AF 1360. In this way, the AF 1360 may influence UPF (re)selection and traffic routing. Based on operator deployment, when AF 1360 is considered to be a trusted entity, the network operator may permit AF 1360 to interact directly with relevant NFs. Additionally, the AF 1360 may exhibit an Naf service-based interface.

The data network 1336 may represent various network operator services, Internet access, or third party services that may be provided by one or more servers including, for example, application/content server 1338.

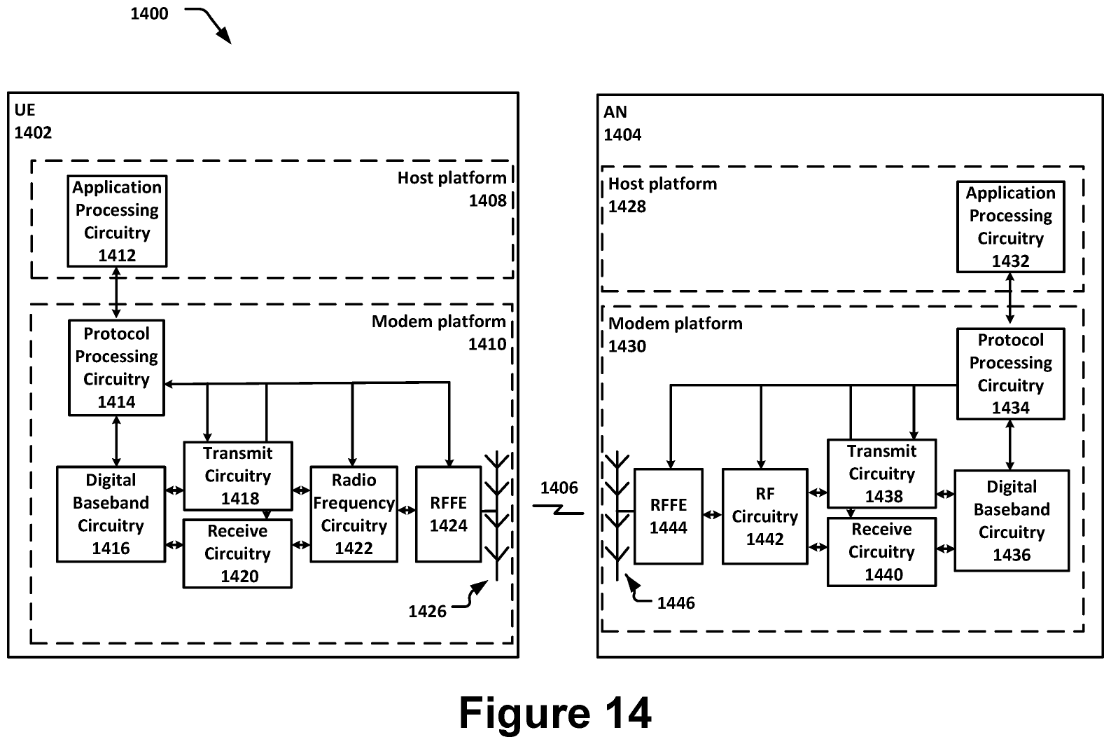

FIG. 14 schematically illustrates a wireless network 1400 in accordance with various embodiments. The wireless network 1400 may include a UE 1402 in wireless communication with an AN 1404. The UE 1402 and AN 1404 may be similar to, and substantially interchangeable with, like-named components described elsewhere herein.

The UE 1402 may be communicatively coupled with the AN 1404 via connection 1406. The connection 1406 is illustrated as an air interface to enable communicative coupling, and can be consistent with cellular communications protocols such as an LTE protocol or a 5G NR protocol operating at mmWave or sub-6 GHZ frequencies.

The UE 1402 may include a host platform 1408 coupled with a modem platform 1410. The host platform 1408 may include application processing circuitry 1412, which may be coupled with protocol processing circuitry 1414 of the modem platform 1410. The application processing circuitry 1412 may run various applications for the UE 1402 that source/sink application data. The application processing circuitry 1412 may further implement one or more layer operations to transmit/receive application data to/from a data network. These layer operations may include transport (for example UDP) and Internet (for example, IP) operations

The protocol processing circuitry 1414 may implement one or more of layer operations to facilitate transmission or reception of data over the connection 1406. The layer operations implemented by the protocol processing circuitry 1414 may include, for example, MAC, RLC, PDCP, RRC and NAS operations.

The modem platform 1410 may further include digital baseband circuitry 1416 that may implement one or more layer operations that are “below” layer operations performed by the protocol processing circuitry 1414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1410 may further include transmit circuitry 1418, receive circuitry 1420, RF circuitry 1422, and RF front end (RFFE) 1424, which may include or connect to one or more antenna panels 1426. Briefly, the transmit circuitry 1418 may include a digital-to-analog converter, mixer, intermediate frequency (IF) components, etc.; the receive circuitry 1420 may include an analog-to-digital converter, mixer, IF components, etc.; the RF circuitry 1422 may include a low-noise amplifier, a power amplifier, power tracking components, etc.; RFFE 1424 may include filters (for example, surface/bulk acoustic wave filters), switches, antenna tuners, beamforming components (for example, phase-array antenna components), etc. The selection and arrangement of the components of the transmit circuitry 1418, receive circuitry 1420, RF circuitry 1422, RFFE 1424, and antenna panels 1426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1414 may include one or more instances of control circuitry (not shown) to provide control functions for the transmit/receive components.

A UE reception may be established by and via the antenna panels 1426, RFFE 1424, RF circuitry 1422, receive circuitry 1420, digital baseband circuitry 1416, and protocol processing circuitry 1414. In some embodiments, the antenna panels 1426 may receive a transmission from the AN 1404 by receive-beamforming signals received by a plurality of antennas/antenna elements of the one or more antenna panels 1426.

A UE transmission may be established by and via the protocol processing circuitry 1414, digital baseband circuitry 1416, transmit circuitry 1418, RF circuitry 1422, RFFE 1424, and antenna panels 1426. In some embodiments, the transmit components of the UE 1404 may apply a spatial filter to the data to be transmitted to form a transmit beam emitted by the antenna elements of the antenna panels 1426.

Similar to the UE 1402, the AN 1404 may include a host platform 1428 coupled with a modem platform 1430. The host platform 1428 may include application processing circuitry 1432 coupled with protocol processing circuitry 1434 of the modem platform 1430. The modem platform may further include digital baseband circuitry 1436, transmit circuitry 1438, receive circuitry 1440, RF circuitry 1442, RFFE circuitry 1444, and antenna panels 1446. The components of the AN 1404 may be similar to and substantially interchangeable with like-named components of the UE 1402. In addition to performing data transmission/reception as described above, the components of the AN 1408 may perform various logical functions that include, for example, RNC functions such as radio bearer management, uplink and downlink dynamic radio resource management, and data packet scheduling.

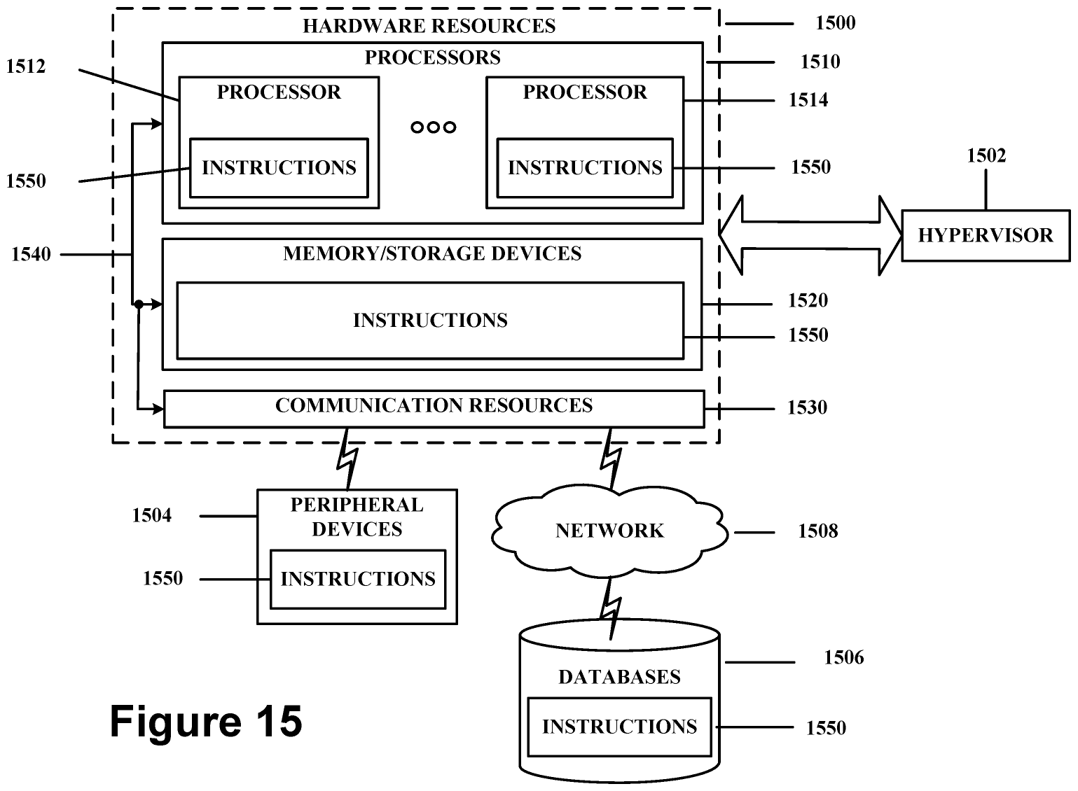

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540 or other interface circuitry. For embodiments where node virtualization (e.g., NFV) is utilized, a hypervisor 1502 may be executed to provide an execution environment for one or more network slices/sub-slices to utilize the hardware resources 1500.

The processors 1510 may include, for example, a processor 1512 and a processor 1514. The processors 1510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1520 may include main memory, disk storage, or any suitable combination thereof. The memory/storage devices 1520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1530 may include interconnection or network interface controllers, components, or other suitable devices to communicate with one or more peripheral devices 1504 or one or more databases 1506 or other network elements via a network 1508. For example, the communication resources 1530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A.1 may include a method comprising:
transmitting, by a UE, uplink control information (UCI) on a physical uplink control channel (PUCCH) or a physical uplink shared channel (PUSCH) using a multiple port based transmission scheme.

Example A.2 may include the method of Example A. 1, wherein when multiple port based transmission is applied for UCI, separate coding is applied for UCI on each port, wherein same coding with same or different scrambling can be used for the UCI transmission on different port.

Example A.3 may include the method of Example A. 1 and/or some other example herein, wherein when different scrambling sequences are applied for the UCI transmission on each port, a fixed offset can be used for the scrambling sequence initialization between two ports for UCI transmission.

Example A.4 may include the method of Example A. 1 and/or some other example herein, wherein block-wised orthogonal cover code (OCC) can be applied for the modulated symbols prior to DFT operation for multiple port UCI transmission on PUSCH.

Example A.5 may include the method of Example A. 1 and/or some other example herein, wherein modulated symbols after DFT operation are directly mapped to different combs for different ports for UCI transmission.

Example A.6 may include the method of Example A. 1 and/or some other example herein, wherein when pre-DFT blocked-wised OCC is applied for UCI transmission on PUSCH, OCC index may be configured by higher layers via MSI, RMSI (SIB1), OSI or RRC signalling or dynamically indicated in the DCI or a combination thereof.

Example A.7 may include the method of Example A. 1 and/or some other example herein, wherein when UCI is mapped to different combs for multiple port transmission, comb index may be configured by higher layers via MSI, RMSI (SIB1), OSI or RRC signalling or dynamically indicated in the DCI or a combination thereof.

Example A.8 may include the method of Example A. 1 and/or some other example herein, wherein when shared DMRS is applied for the transmission of UCI and uplink shared channel (UL-SCH) on PUSCH, comb index or OCC index on each port for UCI transmission on PUSCH can be determined in accordance with the DMRS antenna port (AP) index for PUSCH transmission.

Example A.9 may include the method of Example A. 1 and/or some other example herein, wherein DMRS AP for PUSCH transmission can be first determined in accordance with the indication in the DCI; wherein the comb index or OCC index of UCI on PUSCH for each AP can be determined in accordance with the DMRS AP index.

Example A. 10 may include the method of Example A. 1 and/or some other example herein, wherein when two port transmission is applied for UCI on PUSCH, comb index of 0 or OCC index of 0 is associated with the smaller indicated DMRS AP, while comb index of 1 or OCC index of 1 is associated with the larger indicated DMRS AP for PUSCH transmission.

Example A.11 may include a method of a user equipment (UE), the method comprising:
determining uplink control information (UCI); and
encoding the UCI for transmission on a physical uplink control channel (PUCCH) or a physical uplink shared channel (PUSCH) using a multiple port transmission scheme.

Example A. 12 may include the method of Example A. 11, wherein the multiple port transmission scheme includes applying separate coding for the UCI on each port of a plurality of ports.

Example A. 13 may include the method of Example A. 11 and/or some other example herein, wherein the same coding with the same or different scrambling sequence is used for the transmission of the UCI on the different ports.

Example A. 14 may include the method of Example A.11-13 and/or some other example herein, wherein different scrambling sequences are applied for the transmission of the UCI on respective ports.

Example A.15 may include the method of Example A. 14 and/or some other example herein, wherein a fixed offset is used for the scrambling sequence initialization between two ports for the transmission of the UCI.

Example B.1 may include a method of wireless communication for a fifth generation (5G) or new radio (NR) system, the method comprising:
receiving, by a UE from a gNodeB, an indication of a different modulation order for an initial transmission of a transport block (TB) and retransmission of a TB on a physical uplink shared channel (PUSCH) or a physical downlink shared channel (PDSCH); and
transmitting, by the UE, a dedicated demodulation reference signal (DMRS) for the initial transmission of the TB and the retransmission of the TB, respectively, on the PUSCH; or
receiving, by the UE, a dedicated DMRS for the initial transmission of the TB and the retransmission of the TB, respectively, on the PDSCH.

Example B.2 may include the method of Example B.1 and/or some other example herein, wherein if different transmit powers are used for the transmission of retransmission and initial transmission of TBs, depending on UE capability, time gap may need to be inserted between transmission of retransmission and initial transmission of TBs on PUSCH.

Example B.3 may include the method of Example B.1 and/or some other example herein, wherein a number of symbols for time gap within the PDSCH or PUSCH transmission may be configured by higher layers via minimum system information (MSI), remaining minimum system information (RMSI), other system information (OSI) or dedicated radio resource control (RRC) signalling or dynamically indicated in the DCI or a combination thereof.

Example B.4 may include the method of Example B.1 and/or some other example herein, wherein when uplink control information (UCI) is multiplexed on PUSCH, and if different modulation orders are used for the transmission of UCI, retransmission and initial transmission of TBs, dedicated DMRS(s) are allocated for the UCI, initial transmission and retransmission of the TBs, respectively.

Example B.5 may include the method of Example B.1 and/or some other example herein, wherein if different transmit powers are used for the transmission of UCI, retransmission and initial transmission of TBs, time gap may need to be inserted between transmission of UCI, retransmission and initial transmission of TBs on PUSCH.

Example B.6 may include the method of Example B.1 and/or some other example herein, wherein same modulation order can be used for the transmission of UCI and initial transmission or retransmission of TBs on PUSCH.

Example B.7 may include the method of Example B.1 and/or some other example herein, wherein When same modulation order is employed for the transmission of UCI and initial transmission of TBs on PUSCH or the transmission of the UCI and retransmission, shared DMRS may be used for the transmission of UCI and initial transmission or the transmission of UCI and retransmission, respectively.

Example B.8 may include the method of Example B.1 and/or some other example herein, wherein when same modulation order is used for the transmission of UCI and initial transmission on PUSCH, UCI can be mapped before the initial transmission and shared DMRS is allocated before the UCI.

Example B.9 may include the method of Example B.1 and/or some other example herein, wherein if same modulation order is used for the transmission of UCI and retransmission on PUSCH, UCI can be mapped before the retransmission and shared DMRS is allocated before the UCI.

Example B.10 may include the method of Example B.1 and/or some other example herein, wherein when same modulation orders are used for the transmission of UCI, initial and retransmission of TB(s) on PUSCH, shared DMRS may be used for UCI, initial and retransmission of the TBs on PUSCH, which can be transmitted before the UCI.

Example B.11 may include the method of Example B.1 and/or some other example herein, wherein transmit power difference or transmit power ratio between initial transmission, retransmission and/or UCI may be configured by higher layers via MSI, RMSI (SIB1), OSI or RRC signalling or dynamically indicated in the DCI or a combination thereof.

Example B.12 may include the method of Example B.1 and/or some other example herein, wherein different frequency domain resource allocation (FDRA) can be allocated for the initial and retransmission of TB(s) on PDSCH or PUSCH.

Example B.13 may include the method of Example B.1 and/or some other example herein, wherein separate transmit power command (TPC) fields can be included in the DCI, which is used for the transmission of the initial and retransmission of TB(s) on PUSCH, respectively.

Example B.14 may include a method of a user equipment (UE), the method comprising:
receiving an indication of a first modulation order for an initial transmission of a transport block (TB) and a second modulation order for a retransmission of a transport block (TB) on a physical uplink shared channel (PUSCH), wherein the first and second modulation orders are different; and
encoding, for transmission, a first demodulation reference signal (DMRS) for the initial transmission of the TB and a second DMRS for the retransmission of the TB on the PUSCH, wherein the first and second DMRS are different.

Example B.15 may include the method of Example B.14 and/or some other example herein, wherein different transmit powers are used for the initial transmission and the retransmission, and wherein the method further includes inserting a time gap between the initial transmission and the retransmission.

Example B.16 may include the method of Example B.15 and/or some other example herein, further comprising receiving a configuration of the time gap from a gNB.

Example B.17 may include the method of Example B.16 and/or some other example herein, wherein the configuration is received via minimum system information (MSI), remaining minimum system information (RMSI), other system information (OSI) or dedicated radio resource control (RRC) signalling or dynamically indicated in the DCI or a combination thereof.

Example B.18 may include the method of Example B.14-17 and/or some other example herein, wherein the indication of the first and/or second modulation orders is included in a DCI that schedules the initial transmission and/or the retransmission.

Example B.19 may include a method of a gNB, the method comprising:
encoding, for transmission to a UE, an indication of a first modulation order for an initial transmission of a transport block (TB) and a second modulation order for a retransmission of a transport block (TB) on a physical downlink shared channel (PDSCH), wherein the first and second modulation orders are different; and
encoding, for transmission, a first demodulation reference signal (DMRS) for the initial transmission of the TB and a second DMRS for the retransmission of the TB on the PUSCH, wherein the first and second DMRS are different.

Example B.20 may include the method of Example B.19 and/or some other example herein, wherein different transmit powers are used for the initial transmission and the retransmission, and wherein the method further includes inserting a time gap between the initial transmission and the retransmission.

Example B.21 may include the method of Example B.20 and/or some other example herein, further comprising encoding, for transmission to the UE, a configuration of the time gap from a gNB.

Example B.22 may include the method of Example B.21 and/or some other example herein, wherein the configuration is transmitted via minimum system information (MSI), remaining minimum system information (RMSI), other system information (OSI) or dedicated radio resource control (RRC) signalling or dynamically indicated in the DCI or a combination thereof.

Example B.23 may include the method of Example B.19-22 and/or some other example herein, wherein the indication of the first and/or second modulation orders is included in a DCI that schedules the initial transmission and/or the retransmission.

Example C.1 includes a method to be performed by an electronic device, wherein the electronic device is a part of a user equipment (UE) in a cellular network, the method comprising: identifying a received indication of a first modulation order for an initial transmission of a transport block (TB), and a received indication of a second modulation order for a retransmission of a transport block (TB) on a physical uplink shared channel (PUSCH), wherein the first and second modulation orders are different; and encoding, for transmission based on the indications of the first and second modulation orders, a first demodulation reference signal (DMRS) for the initial transmission of the TB and a second DMRS for the retransmission of the TB on the PUSCH, wherein the first and second DMRS are different.

Example C.2 includes the method of example C.1, and/or some other example herein, wherein different transmit powers are used for the initial transmission and the retransmission, and wherein the method further includes inserting a time gap between the initial transmission and the retransmission.

Example C.3 includes the method of example C.2, and/or some other example herein, further comprising identifying an indication of a configuration of the time gap received from a fifth generation (5G) or higher base station.

Example C.4 includes the method of example C.3, and/or some other example herein, wherein the indication of the configuration is received via minimum system information (MSI), remaining minimum system information (RMSI), other system information (OSI), dedicated radio resource control (RRC) signalling, or dynamically indicated in the DCI.

Example C.5 includes the method of any of example C.1-C.4, and/or some other example herein, wherein the indication of the first modulation order or the indication of the second modulation order is included in a DCI that schedules the initial transmission and/or the retransmission.

Example C.6. A method to be performed by an electronic device, wherein the electronic device is part of a fifth generation (5G) or higher base station in a cellular network, the method comprising: encoding, for transmission to a user equipment (UE), an indication of a first modulation order for an initial transmission of a transport block (TB) and an indication of a second modulation order for a retransmission of a TB on a physical uplink shared channel (PUSCH), wherein the first and second modulation orders are different; and encoding, for transmission based on the first modulation order and the second modulation order, a first demodulation reference signal (DMRS) for the initial transmission of the TB and a second DMRS for the retransmission of the TB on the PUSCH, wherein the first and second DMRS are different.

Example C.7 includes the method of example C.6, and/or some other example herein, wherein different transmit powers are used for the initial transmission and the retransmission, and wherein the method further includes inserting a time gap between the initial transmission and the retransmission.

Example C.8 includes the method of example C.7, and/or some other example herein, further comprising encoding, for transmission to the UE, an indication of a configuration of the time gap.

Example C.9 includes the method of example C.8, and/or some other example herein, wherein the indication of the configuration is transmitted via minimum system information (MSI), remaining minimum system information (RMSI), other system information (OSI), dedicated radio resource control (RRC) signalling, or dynamically indicated in the DCI.

Example C.10 includes the method of any of example C.6-C.9, and/or some other example herein, wherein the indication of the first modulation order or the indication of the second modulation order is included in a DCI that schedules the initial transmission and/or the retransmission.

Example C.11. A method to be performed by an electronic device, wherein the electronic device is part of a user equipment (UE) in a cellular network, the method comprising: identifying uplink control information (UCI); encoding the UCI for transmission on a physical uplink control channel (PUCCH) or a physical uplink shared channel (PUSCH) using a multiple-port transmission scheme; and transmitting the UCI on the PUCCH or the PUSCH on a plurality of ports using the multiple-port transmission scheme.

Example C.12 includes the method of example C.11, and/or some other example herein, wherein the multiple port transmission scheme is based on application of separate coding for the UCI on respective ports of the plurality of ports.

Example C.13 includes the method of example C.11, and/or some other example herein, wherein a same coding is used for the transmission of the UCI on the plurality of ports.

Example C.14 includes the method of any of example C.11-C.13, and/or some other example herein, wherein different scrambling sequences are applied for the transmission of the UCI on respective ports of the plurality of ports.

Example C.15 includes the method of example C.14, and/or some other example herein, wherein a fixed offset is used for the scrambling sequence initialization between two ports of the plurality of ports for the transmission of the UCI.

Example C.16. A method to be performed by an electronic device, wherein the electronic device is part of a base station in a fifth generation (5G) or higher cellular network, the method comprising: identifying uplink control information (UCI) received from a user equipment (UE) on a physical uplink control channel (PUCCH) or a physical uplink shared channel (PUSCH); and processing the UCI; wherein the UCI was transmitted by the UE on a the PUCCH or the PUSCH on a plurality of ports using the multiple-port transmission scheme.

Example C.17 includes the method of example C.16, and/or some other example herein, wherein the multiple port transmission scheme is based on application, by the UE, of separate coding for the UCI on respective ports of the plurality of ports.

Example C.18 includes the method of example C.16, and/or some other example herein, wherein a same coding is used for the transmission of the UCI on the plurality of ports.

Example C.19 includes the method of any of example C.16-C.18, and/or some other example herein, wherein different scrambling sequences are applied for the transmission of the UCI on respective ports of the plurality of ports.

Example C.20 includes the method of example C.19, and/or some other example herein, wherein a fixed offset is used for the scrambling sequence initialization between two ports of the plurality of ports for the transmission of the UCI.

Example Z01 may include an apparatus comprising means to perform one or more elements of a method described in or related to any of examples A. 1-C.20, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A. 1-C.20, or any other method or process described herein.

Example Z03 may include an apparatus comprising logic, modules, or circuitry to perform one or more elements of a method described in or related to any of examples A.1-C.20, or any other method or process described herein.

Example Z04 may include a method, technique, or process as described in or related to any of examples A.1-C.20, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A. 1-C.20, or portions thereof.

Example Z06 may include a signal as described in or related to any of examples A.1-C.20, or portions or parts thereof.

Example Z07 may include a datagram, packet, frame, segment, protocol data unit (PDU), or message as described in or related to any of examples A.1-C.20, or portions or parts thereof, or otherwise described in the present disclosure.

Example Z08 may include a signal encoded with data as described in or related to any of examples A.1-C.20, or portions or parts thereof, or otherwise described in the present disclosure.

Example Z09 may include a signal encoded with a datagram, packet, frame, segment, protocol data unit (PDU), or message as described in or related to any of examples A. 1-C.20, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A. 1-C.20, or portions thereof.

Example Z11 may include a computer program comprising instructions, wherein execution of the program by a processing element is to cause the processing element to carry out the method, techniques, or process as described in or related to any of examples A. 1-C.20, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACK Acknowledgement
ACID Application Client Identification
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICH Common Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator, CSI-RS Resource
Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Setver
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signaling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal'naya NAvigatsionnaya Sputnikovaya Sistema (Engl.:
Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure (https is http/1.1 over SSL,
i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN Constraint length of the convolutional
code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement (TSG T WG3
context)
MAC-IMAC used for data integrity of signalling messages (TSG T WG3
context)
MANO Management and Orchestration
MBMS Multimedia Broadcast and Multicast Service
MBSFN Multimedia Broadcast multicast service Single Frequency
Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information, MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol, Packet Data Convergence
Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quaternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol, Service Data Adaptation
Protocol layer
SDL Supplementary Downlink
SDNF Structured Data Storage Network Function
SDP Session Description Protocol
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal Received Power
SS-RSRQ Synchronization Signal based Reference Signal Received
Quality
SS-SINR Synchronization Signal based Signal to Noise and Interference
Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
UDSF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-Measurement TimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. A user equipment (UE) comprising:
memory to store a received indication of a first modulation order for an initial transmission of a transport block (TB), and a received indication of a second modulation order for a retransmission of a transport block (TB) on a physical uplink shared channel (PUSCH), wherein the first and second modulation orders are different; and
processor circuitry to encode, for transmission based on the indications of the first and second modulation orders, a first demodulation reference signal (DMRS) for the initial transmission of the TB and a second DMRS for the retransmission of the TB on the PUSCH, wherein the first and second DMRS are different.

22. The UE of claim 21, wherein different transmit powers are used for the initial transmission and the retransmission, and wherein the processor circuitry is further to insert a time gap between the initial transmission and the retransmission.

23. The UE of claim 22, wherein the processor circuitry is further configured to identify an indication of a configuration of the time gap received from a fifth generation (5G) or higher base station.

24. The UE of claim 23, wherein the indication of the configuration is received via minimum system information (MSI), remaining minimum system information (RMSI), other system information (OSI), dedicated radio resource control (RRC) signalling, or dynamically indicated in the DCI.

25. The UE of claim 21, wherein the indication of the first modulation order or the indication of the second modulation order is included in a DCI that schedules the initial transmission or the retransmission.

26. One or more non-transitory computer-readable media comprising instructions that, upon execution of the instructions by one or more processors of a fifth generation (5G) or higher base station in a cellular network, is to cause the base station to:
encode, for transmission to a user equipment (UE), an indication of a first modulation order for an initial transmission of a transport block (TB) and an indication of a second modulation order for a retransmission of a TB on a physical uplink shared channel (PUSCH), wherein the first and second modulation orders are different; and
encode, for transmission based on the first modulation order and the second modulation order, a first demodulation reference signal (DMRS) for the initial transmission of the TB and a second DMRS for the retransmission of the TB on the PUSCH, wherein the first and second DMRS are different.

27. The one or more non-transitory computer-readable media of claim 26, wherein different transmit powers are used for the initial transmission and the retransmission, and wherein the method further includes inserting a time gap between the initial transmission and the retransmission.

28. The one or more non-transitory computer-readable media of claim 27, wherein the instructions are further to cause the base station to encode, for transmission to the UE, an indication of a configuration of the time gap.

29. The one or more non-transitory computer-readable media of claim 28, wherein the indication of the configuration is transmitted via minimum system information (MSI), remaining minimum system information (RMSI), other system information (OSI), dedicated radio resource control (RRC) signalling, or dynamically indicated in the DCI.

30. The one or more non-transitory computer-readable media of claim 26, wherein the indication of the first modulation order or the indication of the second modulation order is included in a DCI that schedules the initial transmission or the retransmission.

31. A user equipment (UE) comprising:
memory to store uplink control information (UCI);
one or more processors configured to:
encode the UCI for transmission on a physical uplink control channel (PUCCH) or a physical uplink shared channel (PUSCH) using a multiple-port transmission scheme; and
facilitate transmission of the UCI on the PUCCH or the PUSCH on a plurality of ports using the multiple-port transmission scheme.

32. The UE of claim 31, wherein the multiple port transmission scheme is based on application of separate coding for the UCI on respective ports of the plurality of ports.

33. The UE of claim 31, wherein a same coding is used for the transmission of the UCI on the plurality of ports.

34. The UE of claim 31, wherein different scrambling sequences are applied for the transmission of the UCI on respective ports of the plurality of ports.

35. The UE of claim 34, wherein a fixed offset is used for the scrambling sequence initialization between two ports of the plurality of ports for the transmission of the UCI.
